(19) United States
(12) Patent Application Publication
(10) Pub. No.: US 2012/0021400 A1
(43) Pub. Date: Jan. 26, 2012

(54) MULTI-DIRECTION BOARD AND ACCESSORY INTERLOCK SYSTEM

(75) Inventor: Woon Shing ("Timothy") Tai, Tsuen Wan (HK)

(73) Assignee: ARTAPOWER INTERNATIONAL GROUP LIMITED, Tsuen Wan (HK)

(21) Appl. No.: 12/842,814

(22) Filed: Jul. 23, 2010

(51) Int. Cl. B43L 5/00; F16B 1/00

(52) U.S. Cl. 434/413; 403/359.5

(57) ABSTRACT

A modular system is described and claimed featuring one of numerous connector embodiments having a plurality of the same or different component channels for providing a user flexibility in the types and arrangements of modular components for the office space. The connectors may have channels on one or more of a plurality of faces of the connector—front, bottom, back and top, and the components have complimentary configurations for slidable engagement with the channels of the connectors.

### BACKGROUND

The present invention relates generally to office supply components and, more specifically, to a multi-direction interlocking connector system that permits customization and expansion of wall boards and accessories.

Functional office supplies have been around for centuries, but have evolved dramatically with the advent of a wider variety of materials for construction, and also with the increasing use of such supplies not only by the working population but by those who maintain offices at home. Lighter weight materials, and materials that permit a greater degree of molding, permit a large variety of office tools of almost endless shapes and sizes. Notwithstanding the virtual world of electronic communications and storage, there remains a robust need for physical office tools that serve users in association with their home or business offices.

One of the more popular office supplies, used even beyond the work environment context, are boards and/or wall displays the provide a user the ability to display visually information for easy retrieval and access. The cork board (aka bulletin board), with its complementary pin (tack) components, and later the white board, with its complementary magnetic components, have been particularly popular because of the ability to easily display and interchange documentary and/or visual information at a whim, and yet preserve the immediate accessibility of the information. Indeed, even office cubicles are constructed of materials that permit users to “post” documentary information on the walls. Readers can appreciate office space covered with information in an arguable chaotic order. Others might call it clutter, but regardless the ability to arrange immediately accessible displayable information becomes paramount to a user in an environment heavy with transactional traffic.

There does not seem to be an end to the variety of mechanical business tools, including display boards, generated and sold to make the user's transactional life more convenient and/or easier, both at home and/or at work. Indeed, one feature that appeals to users often is a modular capability; the ability to connect and disconnect components together as desired by the user. It seems that customization is important to users, so modularity adds the freedom to customize a particular arrangement of office tools, or rearrange the components at a later time. It should be note that aesthetics also plays a role in the configuration of office tools, often dictating form over function, although more often function drives the design most of the time.

An example of modularity is disclosed in U.S. Pat. No. 5,658,635 to Davis et al., entitled Bulletin Board and Accessory Attaching Mechanism. In that patent, issued on Aug. 19, 1997, Davis et al. have disclosed an example of what users are often looking for in convenient accessibility; in particular, a display board with a frame configured to permit attachment of numerous accessories. The accessories include key holders, writing implement holders, paper holders, business card holders, etc.

Another example of common display boards configured for holding accessories is shown in U.S. Pat. No. 6,837,715 to Beno. That patent, issued in January of 2005, discloses a combination dry erase board and tack board in which the configuration of the board itself is such that it permits tools to reside in an easily detachable fashion. Numerous other publications exist describing variations on these general themes.

An important feature in a display board device is the connector or connector system, the feature configured to permit detachability and reattachability of one modular component with another. The connector or connector system may be an integral feature, as on the frame of the Davis et al. patent. Or it may form the frame itself, as in U.S. Pat. No. 7,632,103 to Williams et al., which issued on Dec. 15, 2009. In the Williams patent, the connector system is described as being a bottom frame member that includes a cover plate and a channel for supporting a detachable tray (for writing implements and erasers and the like).

### SUMMARY

Although a certain flexibility may be provided by earlier modular office systems, none provide the enhanced flexibility and breadth of arrangements provided by the connector system described and claimed herein. In that regard, the present inventive embodiments provide a support for a variety of modular components in three dimensions.

In one embodiment, first and second engaging connectors are configured to support modular components above and below the connectors, in a somewhat planar fashion parallel to a wall. The connectors are further configured to support modular components in a third direction; namely, outwardly—or perpendicularly—away from the planar orientation of the other components.

Each of the connectors includes one or more channels and/or projections that are configured to permit engagement of projections of one connector with a channel of the other connector. Modular components are also provided that comprise either similar projections suitable for engagement with channels of the connectors, or the modular components are themselves so configured to fit within the channels of the connectors. In this way, planar and orthogonal arrangements are permitted with modular components in a sturdy and stable fashion to enhance functional convenience to the user.

Complementary connectors are also contemplated that permit additional modular components to be added in a lateral direction within the planar arrangement; i.e., in a side-by-side fashion. With these connectors included, an entire modular system is provided that permits extension of modular components upwardly, downwardly, sideways and outwardly, a substantial level of modular flexibility not provided in the prior art. Further details are provided below of some of the embodiments that come within the scope of the invention claimed herein.

### BRIEF DESCRIPTION OF THE FIGURES

The detailed description of some embodiments of the invention will be is made below with reference to the accompanying figures, wherein like numerals represent corresponding parts of the figures.

FIG. 1 is an orthogonal schematic, partially cutaway, of one embodiment of multi-directional connectors for modular office components;

FIG. 2 is a cross-sectional schematic view of the connectors of the embodiment of FIG. 1;

FIG. 3 is a schematic of an alternative embodiment of connector with complementary alternative modular components suitable for engagement with the connector;

FIG. 4 is a schematic of yet another embodiment of connector with complementary alternative modular components suitable for engagement with the connector;

FIG. 5 is an orthogonal schematic showing multiple components in slidable relative positions utilizing multiple connectors described herein;

FIG. 6 is a schematic of yet another embodiment of connector having angled connector channels, with complementary alternative modular components suitable for engagement with the connector;

FIG. 7 is a schematic showing connector of FIG. 6 and complimentary components assembled together with the connector;

FIG. 8 is a schematic of another embodiment of a modular component suitable for engagement with the connector whereby the modular component comprises a feature permitting adjustable positioning of part of the component;

FIG. 9 is an orthogonal schematic of the adjustable position component shown in FIG. 8;

FIG. 10A and 10B show schematic views of yet an additional connector and complimentary component in disassembled and assembled configurations, respectively;

FIG. 11 is a schematic view of the component of FIGS. 10A and 10B.

### DETAILED DESCRIPTION OF CERTAIN EMBODIMENTS

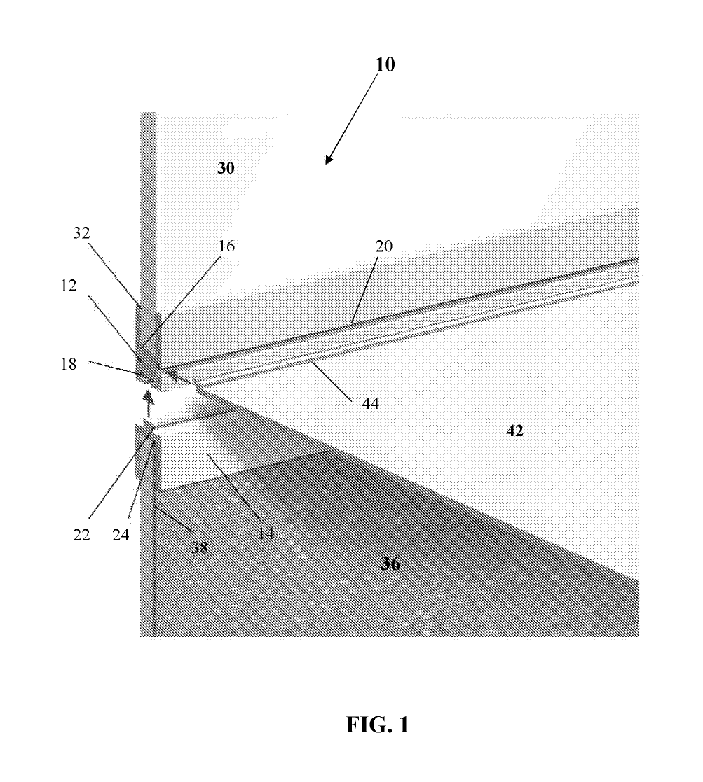

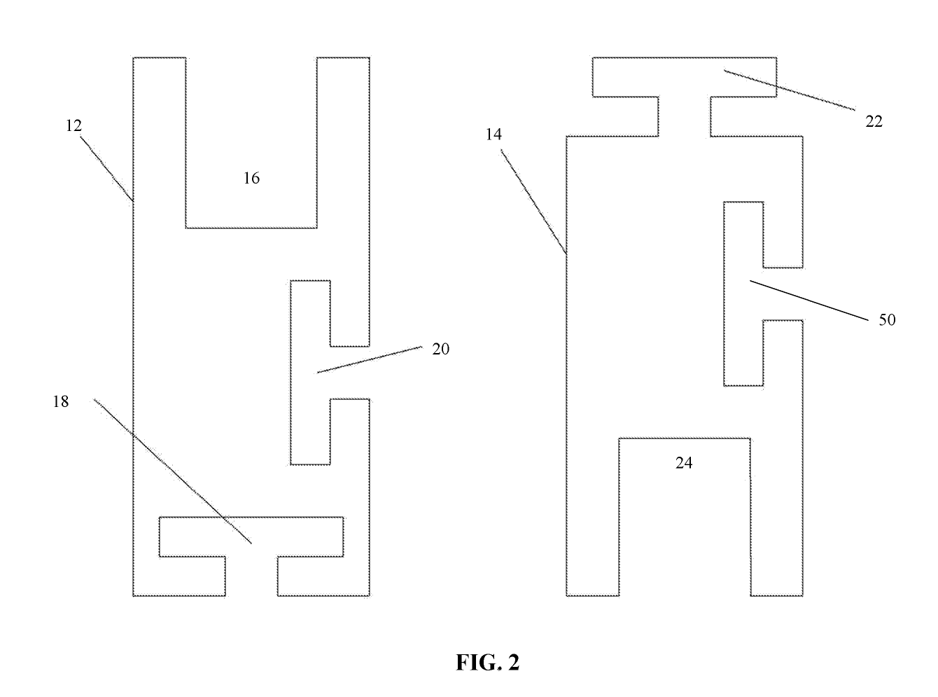

By way of example, referring to FIGS. 1 and 2, one embodiment of the connector system 10 comprises a first multi-directional connector 12 and a second multi-directional connector 14. The first connector 12 comprises a first connecting channel 16 and a second connection channel 18. Optionally, but advantageously, the first connector 12 further comprises a third orthogonally positioned connection channel 20. The first and second connection channels 16, 18 may be aligned or not, or may be in the same axis or not. The particular geometric relationship is not critical. It is important, however, that the third connection channel 20 be positioned in a generally different direction from the first and/or second connection channels 16, 18 so as to provide a true multi-directional component support connector system designed to give the user enhanced flexibility and functionality.

The second connector 14 is designed preferably to engage the first connector in a sturdy and stable fashion, and comprises a connecting projection 22 and a connection channel 24. Optionally, as shown in FIG. 2, the second connector may comprise an alternative embodiment multi-directional connector 14a that comprises a second connection channel 50 similar, although not necessarily identical, to the third connection channel 20 of the first connector 12.

Desirably, the system 10 further comprises components configured to be supported by the first and/or second multi-directional connectors 12, 14 in a sturdy and stable manner, where the components comprise tools for the user. For example, in one embodiment, a first component 30 comprises a wall board with a first end 32 configured to securely fit within the first connection channel 16 of the first connector 12. Similarly, a second component 36 may be a wall board comprising a first end 38 configured to securely fit within the connection channel 24 of the second connector 14. Importantly, a third component 42 may comprise a shelf or other device comprising a first end 44 configured to fit securely within the orthogonally-positioned connection channel 20 of the first connector 12. The first and second connectors 12, 14 permit interchangeable components in multiple directions in a sturdy manner.

In the embodiment illustrated in FIGS. 1 and 2, the second and third connection channels 18, 20 of first connector 12, and the second connection channel 50 of second connector 14, are configured in a letter “T” arrangement, not unlike a tongue and groove mating system used for engagement of adjacent components. The configuration of the channel per se is not critical as long as the geometry permits relatively easy engagement of a component to the connector but with a sturdy and stable securement. Office users are likely to apply meaningful downward forces on the components, particularly the outwardly directing third component (e.g., shelf), so it is important that the configuration of the channels and materials chosen for the connectors and components permit reliable support. In one embodiment, it is contemplated that the connectors 12 and 14 would comprise a lightweight and durable aluminum or aluminum alloy, although other similarly sturdy materials would be acceptable as well. For example, a sturdy plastic material may be employed in which the plastic is extruded, injection molded, or otherwise shaped in another manufacturing technique to conform to the configurations and possibilities taught and suggested herein. It is desirable that the material chosen be lightweight but sturdy to accomplish the functions described.

In one embodiment, the first component 30 may be a wall board having dry erase functionality, although it may be one or a hybrid of a variety of possible surfaces. The board may be magnetized to permit attachment of magnets for securing papers to the board.

Likewise, in one embodiment, second component 36 may be a wall board having pin-accepting construction, such as a traditional corkboard material. It may also be of hybrid arrangement where part of the board has one material (e.g., magnetized dry erase material) and where the other part has a different material (e.g., a cork material). Other types of boards may be used as well, including those that provide calendar dates, etc.

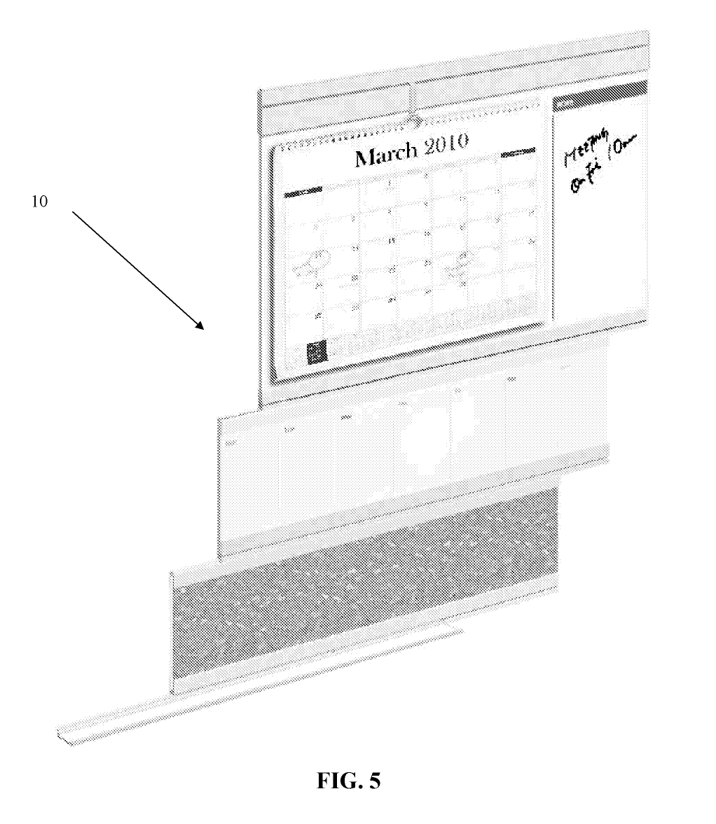

Referring to FIG. 5, it is contemplated that modular components may be interchanged by sliding a component into a connector and/or into another component in lateral fashion. So for example, if one modular board component were placed within the channel of a connector, and another board were similarly slid into a channel of a different connector, the boards could be joined together by sliding one connector's projection into the other connector's complimentary channel. Although other engagement configurations would work, including an engagement configuration in which one component is pushed into (or popped into) the other component, it is believed that the sliding arrangement for engaging the components described herein provide a sturdy system for the user.

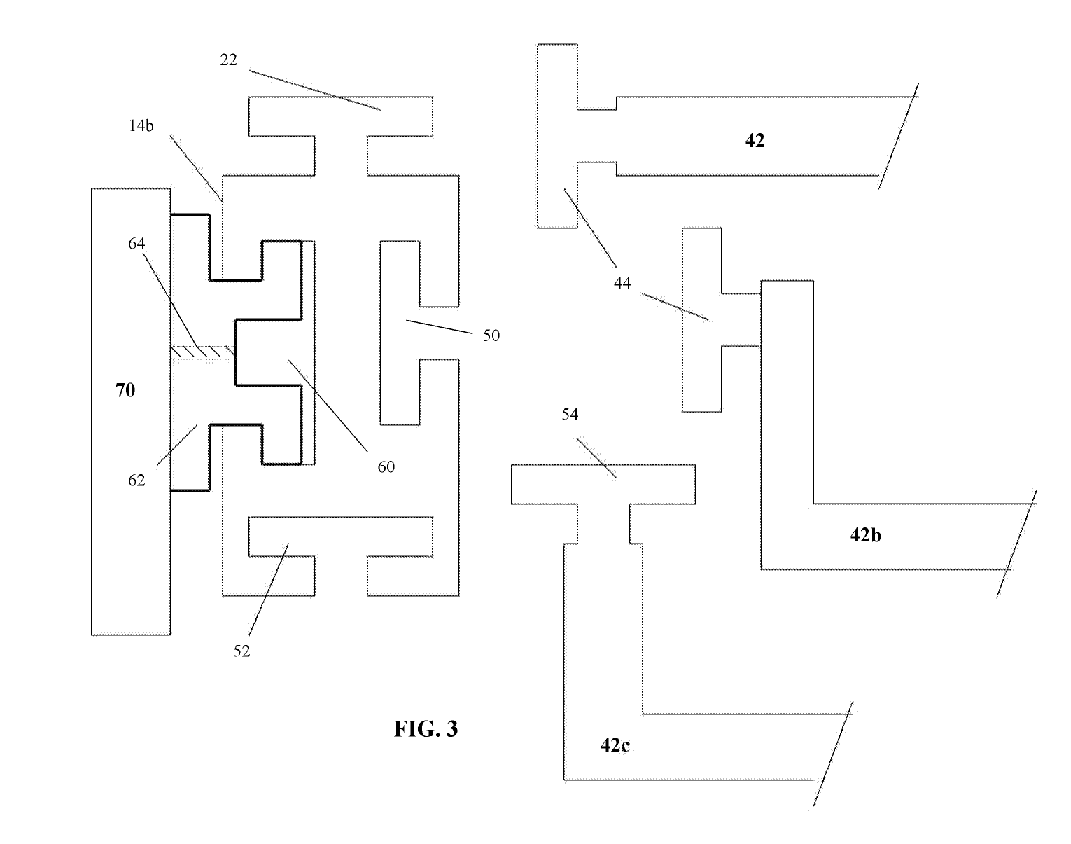

It is contemplated that some connector embodiments include one or more of various means for attaching the modular system to a wall or vertical support. A connector may simply be adhered to the vertical support using conventional fastening or adhering means. Or, as in the exemplary embodiment of FIG. 3, an alternative multi-directional connector 14b (comprising connecting projection 22 and a connection channels 50, 52) would also include a support channel 60 configured to slidably mate with a wall bracket 62, which itself can be affixed to the vertical support 70 using conventional fastening means through bore 64. The advantage of using a wall bracket 62 configured to slidably mate with the support channel 60 of connector 14b is that it permits ready interchangeability with other connectors described and contemplated herein for supporting other modular components.

At least one modular component complimentary with multi-directional connector 14b of FIG. 3 is a horizontally-oriented shelf 42 having connecting projection 44, also as shown in FIG. 1. Depending upon what other modular components may be in use in the system, the shelf 42 may be configured such that it extends orthogonally directly outwardly from the connector 14b, or an alternative shelf 42b may be used that extends downwardly (or upwardly if so desired) before extending outwardly. Like shelf 42, alternative shelf 42b comprises a connecting projection 44 for engagement with the connection channel 50 of connector 14b. It is contemplated that yet another alternative shelf 42c could be used with connector 14b where shelf 42c has a similar L-shaped cross-section as shelf 42b but instead includes a connection projection 54 oriented orthogonally from connection projection 44. In this arrangement, the shelf may engage the multi-directional connector 14b at connection channel 52 rather than connection channel 50, giving the user some additional flexibility without sacrificing any functionality.

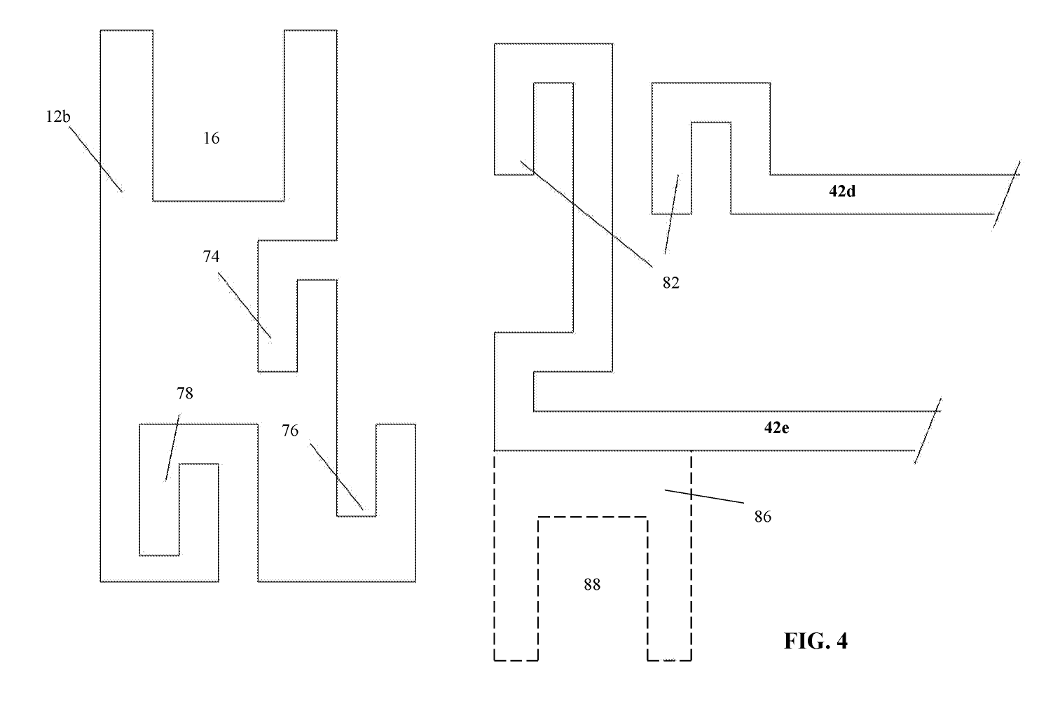

Referring now to FIG. 4, yet additional alternative embodiments of multi-directional connectors may be described, along with alternative embodiments of modular components complementary to the multi-directional connectors. Specifically, multi-directional connector 12b comprises a top connection channel 16, two orthogonally-positioned connection channels 74 and 76, and a bottom connection channel 78. Top connection channel 16 is the same as the top connection channel 16 of multi-directional connector 12 shown in FIGS. 1 and 2. However, as can be appreciated from the variety of possible configurations applicable to the inventive embodiments herein, connection channels 74, 76, and 78 comprise a different geometrical configuration than the connection channels 18 and 20 of multi-directional connector 12 shown in FIGS. 1 and 2, and the connection channels 50 and 52 of multi-directional connector 14b shown in FIG. 3. The former have more of an L-shaped or U-shaped configuration, while the latter have T-shaped configurations. Each are designed to provide maximum engagement between connector and modular component (or between connector and connector, depending) to provide a sturdy system. As with the earlier-described embodiments, the multi-directional connectors exemplified in FIG. 4 are configured for engagement with adjacent components by lateral sliding of one relative to the other.

Still referring to FIG. 4, it can be appreciated that yet additional embodiments of modular components may be used with the multi-directional connectors, including multi-directional connector 12b. To complement the connection channels 74, 76 and 78, modular component shelves 42d and 42e each have at one end 82 a correspondingly L-shaped (or U-shaped) connection configuration. Either one of the shelves 42d or 42e, or both, may be used depending upon which connection channel (either 74, 76 or 78) is used.

Optionally, an additional connector 86 may be employed on modular shelf 42e to add yet additional modular components; whereby the connector 86 defines a connection channel 88 for accepting components (such as those described above) therein. In concept, the multi-directional connector 12b can accommodate four modular components, including an upper board in channel 16, two shelves spaced apart (42d and 42e), and a lower board) using the channel 88 of shelf 42e. The number of modular components and the arrangement of each relative to each other is variable and is almost limitless in possibilities. Although not shown, the multi-directional connector 12 of FIG. 1 and the multi-directional connector 12b of FIG. 4 may each have, if desired, a support channel similar to the multi-directional connector 14b of FIG. 3 to accommodate a corresponding wall bracket.

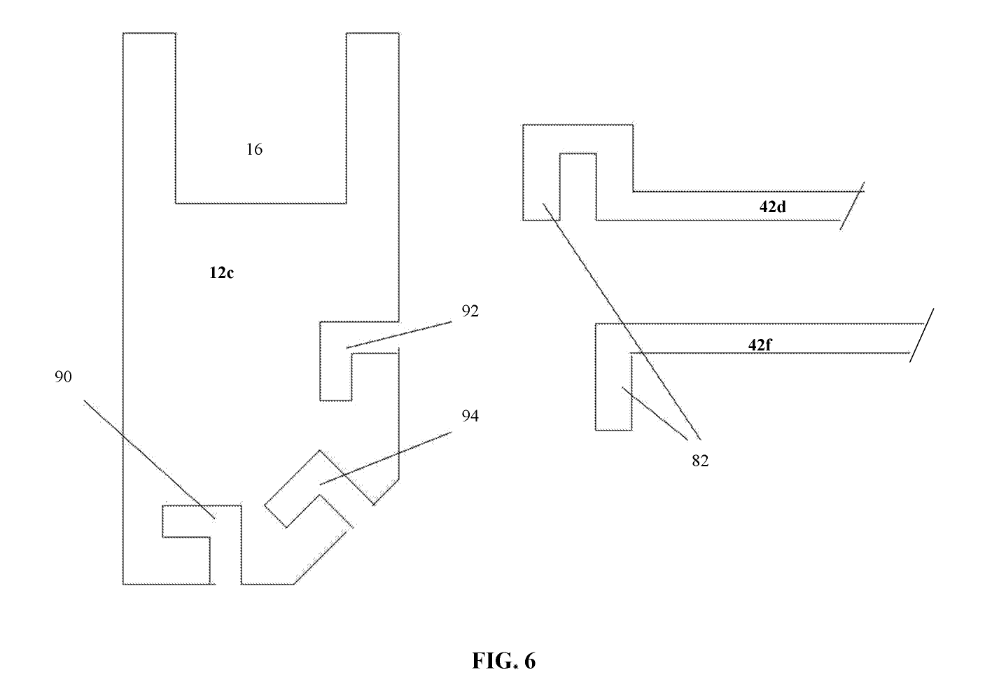

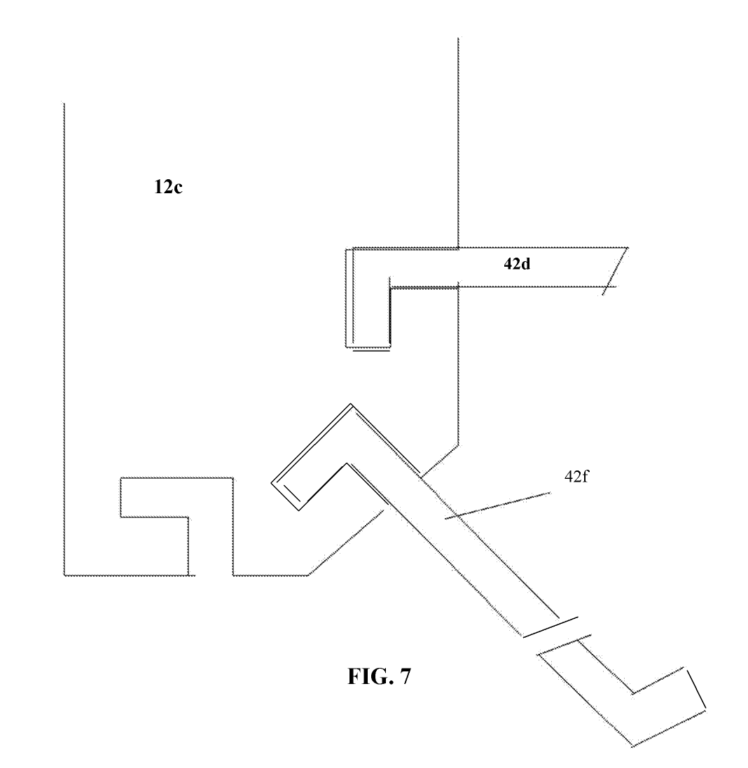

Yet other embodiments are contemplated that enhance flexibility of component positions. Referring to FIGS. 6 and 7, a connector 12c comprises previously-explained component channel 16 and a plurality of additional connector channels 90, 92 and 94. Importantly, connector channel 92 is angled with respect to connector channels 90 and 94 so that components may be positioned beyond the mere vertical or horizontal arrangement. Depending upon the size constraints, the connector 12c, or any variation of the connector (keeping in mind the teaching of the specification herein), numerous connection channels can be provided at numerous angles. The function or intent of use of components may be taken into consideration in determining the desired angle of connection channel.

As with other embodiments described above, connector channels 90, 92 and 94 may be configured in one of a number of arrangements and geometries, and need not even be all of the same configuration. However, it is desired that the configuration be one that is sufficient sized and spaced to permit structural integrity in supporting components therewithin. In the embodiment illustrated in FIGS. 6 and 7, the connector channels 90, 92 and 94 are configured in a generally L-shaped arrangement complementary of the projecting ends 82 of component shelves 42d and 42f, similar to the ones shown in FIG. 4. FIG. 7 shows that multiple components may be engaged simultaneously, providing an array of helpful tools for the user. Although only two of the channels are illustrated in use, it can be appreciated that all three be used simultaneously. With an upper component, a total of four could be in use at the same time.

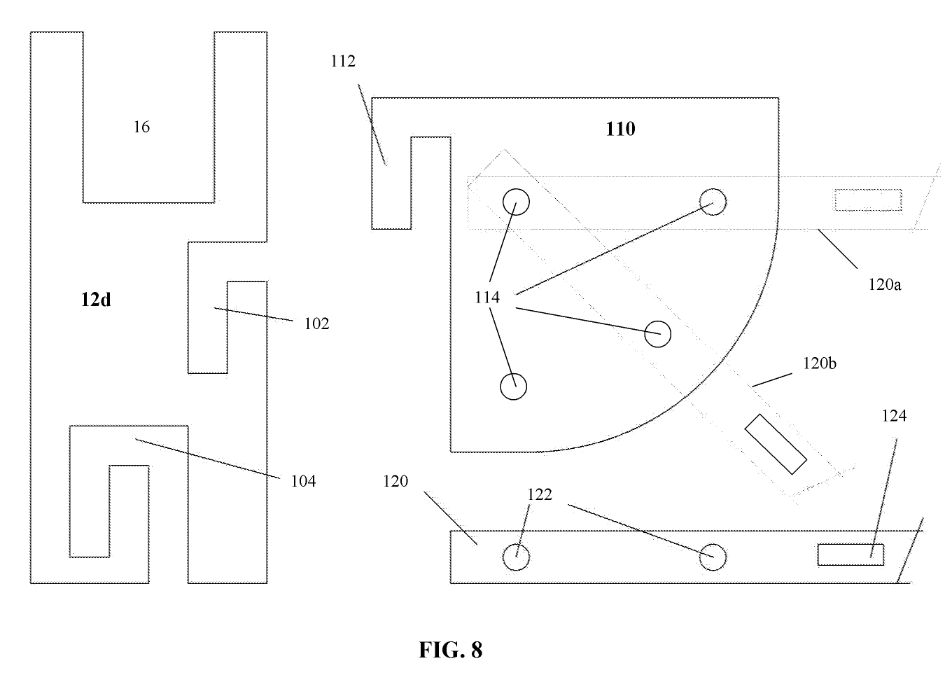

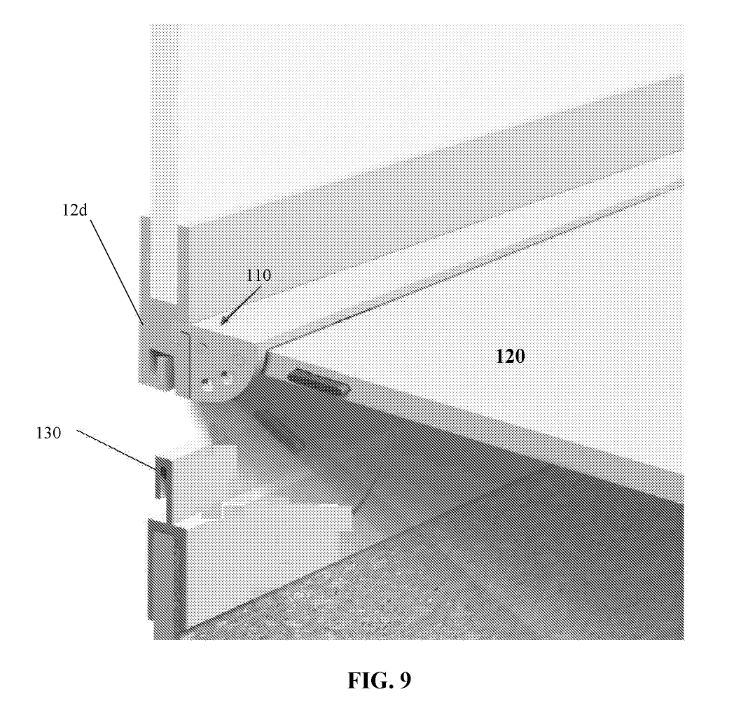

The flexibility contemplated by the present application is yet further exemplified in additional embodiments that comprises adjustable position features. Specifically, referring to FIGS. 8 and 9, a component connector 12d comprises the component channel 16 (similar to earlier connectors 12, 12a, 12b, 12c) as well as additional connector channels 102 and 104. The channels 102, 104, like those described above, provide attachable and detachable support to optional components, and may comprise any number of possible configurations and arrangements, in size, shape and angle. Adjustable connector 110 is provided complementary to component connector 12d and comprises connector end 112 for engagement with channel 102 of connector 12d in a supported manner. Adjustable connector 110 comprises a housing having a plurality of position holes 114 that are preferably arranged in pairs of at least two to permit detachable engagement with component 120 (in this particular embodiment, a shelf) comprising a plurality of depressible position projections 122. A release mechanism (e.g., a spring-biased button) 124 is also provided on component shelf 120 that is mechanically linked to the depressible position projections 122. If desired a single mechanism 124 may be provided on the component shelf 120, or multiple mechanisms on either side of the component so that when the component is grasped with two hands on opposing sides, both hands may squeeze together to depress the mechanism, which simultaneously depresses position projections 122 inwards.

With such an arrangement, component shelf 120 may be placed in one of several different positions within adjustable connector 110 as shown (at positions 120a and 12b) by depressing the mechanism 124 such that the position projections 122 likewise depress inwardly, permitting the component to be slided into the housing of adjustable connector 110. Once properly aligned, the release mechanism may be released permitting the position projections 122 to extend within openings 114 of the adjustable connector. While the third position provided on adjustable connector 110 is not shown being used, the reader may appreciate that all three positions may be used singly or simultaneously with components configured with depressible position projections 122 and a release mechanism.

As with other embodiments described above, connector channel 104 may be used to support one of numerous possible components such as component 130 shown in FIG. 9. As one or ordinary skill in the art may appreciate, the present systems and embodiments provide a large degree of flexibility to add and remove components, and to interchange components as desired by the user.

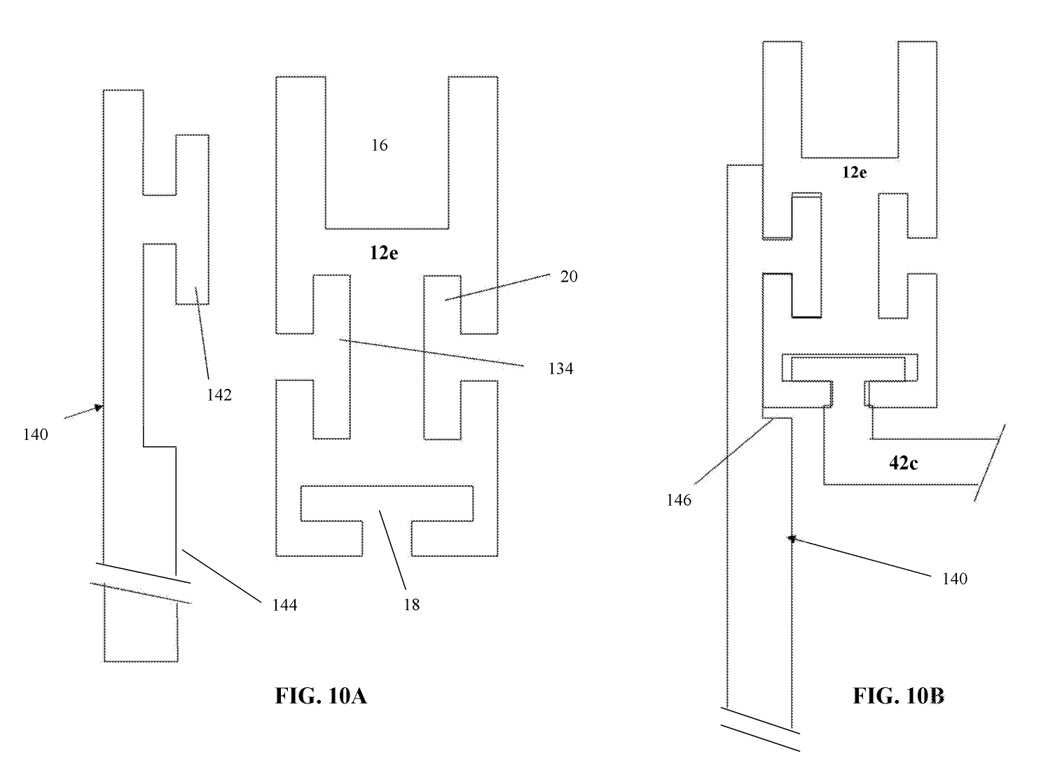

Other embodiments contemplated provide yet additional flexibility and expansion capability. Referring to FIGS. 10A and 10B, connector 12e comprises first connection channel 16, second connection channel 18 and third connection channel 20, as described above in association with FIG. 2. In this case, however, connector 12e comprises a fourth connection channel 134. While connection channel 134 has a similar configuration to connection channels 18 and 20, it may have a different configuration that, as discussed above, provides stable support and easy slidability to a complimentary modular component configured to engage the connection channel. In the embodiment shown in FIG. 10A, complementary component 140 is provided comprising a connection projection 142 configured to slide within connection channel 134. Modular component 140 also comprises a useable display surface 144 that projects below connector 12e for access by the user.

As shown in FIG. 10B, modular component 140 comprises a shoulder 146 to accommodate a difference in board thickness from adjacent the connector 12e to below the connector 12e, although the shoulder and thickness differential is an optional arrangement. Also, as shown in FIG. 10B, multiple components can be placed into support position in connector 12e, including modular component 42c discussed above in association with FIG. 3. While not shown, it can be appreciated that other modular components could be placed in connection channels 20 and 16 of connector 12e, permitting a panoply of optional useful surfaces for the user, all slideably disengageable with the connector 12e when so desired.

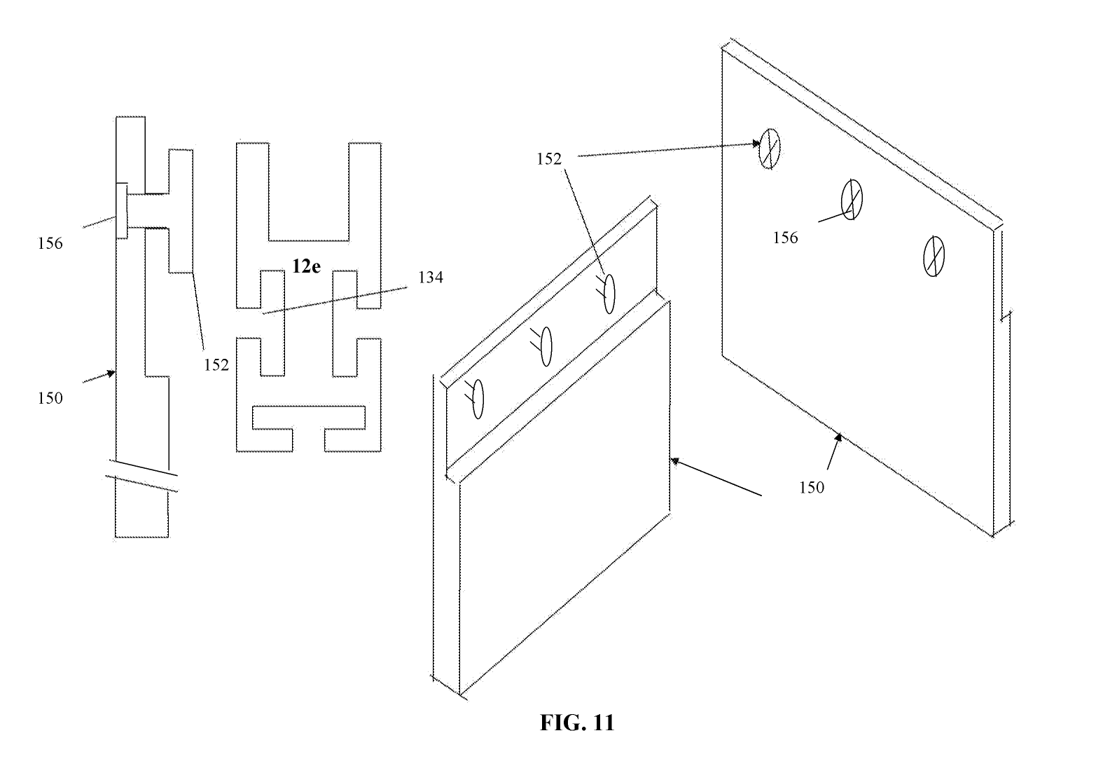

It should be appreciated that sliding engagement of a modular component to a connector is but one way of secure engagement. Other means of easily detachable engagement are contemplated as well, including a snap-fit connection, a quick-disconnect release connection, etc. One particular arrangement can be described in association with FIG. 11. There, a connector such as that described in association with FIGS. 10A and 10B is shown with appropriate connection channels. Like the modular component 140 of FIGS. 10A and 10B, alternative modular component 150 also comprises projections 152. However, unlike the continuous projection described above, the projections of alternative modular component 150 are discrete rotatable projections 152 that can be controlled with an accessible face 156 to the user for rotating the projections. For example, a slot or slots may be provided in face 156 to insert a flat-head screwdriver to rotate the entire projection into a horizontal or vertical position for easy insertion into the appropriate complementary connection channel (e.g., 134).

Most of the discussion above focuses on expanding with modular components above, below, rearward and forward of the connector. However, if so desired, modular components may be placed in a side-by-side fashion where width-wise expansion is desired. For example, referring to FIGS. 1 and 2, expansion connectors (not shown) may be used that slidably insert into a portion of channels 18 and/or 20 of connector 12 and a complementary connector and component system (also not shown) that are similar or the same as those described above. With such expansion connectors, the present systems may be expanded upwardly, downwardly, sideways, and outwardly, all simultaneously if so desired. It can be appreciated that one of a number of different possible connection mechanisms may be used to permit side-ways expansion of the modular components.

What is claimed is:

1. An office supply connector system suitable for use in customizing and expanding the use of modular components, the system comprising a multi-direction connector comprising a plurality of faces along orthogonal axes, each face of the plurality of faces comprising a connection channel for accepting engagement of a complementary component having a portion configured to engage the channel so that the connector supports the component such that the component does not inadvertently detach.

2. The connector system of claim 1, wherein the connector has a first face with a channel for accepting therein a modular board component.

3. The connector system of claim 2, wherein the connector has a second face with a channel for accepting therein a modular shelf component.

4. The connector system of claim 1, further comprising a second connector configured to slidably engage the first connector.

5. The connector system of claim 4, wherein the second connector comprises a multi-direction connector that itself comprises a plurality of faces along orthogonal axes, each face of the plurality of faces comprising a connection channel for accepting engagement of a complementary component having a portion configured to engage the channel.

6. The system of claim 5, wherein the modular component is an erasable whiteboard.

7. A system for providing expandable usable services to a user in an office environment, the system comprising:
a multi-direction connector having a plurality of surfaces, wherein at least some of the plurality of faces comprises a connection channel configured to support a like-configured projection of a modular component in the connection channel for sturdy support thereof; and
a modular component comprising a projection configured to slideably engage a first connection channel on the multi-direction connector.

8. The system of claim 7 further comprising a second modular component comprising a projection configured to slideably engage a second connection channel on the multi-direction connector.

9. The system of claim 7, wherein at least one of the connection channels comprises an angled connection channel oriented at an angle less than 90° from a front face of the connector.

10. The system of claim 9, wherein at least a portion of the modular component is positioned at an angle to the front face of the connector when the modular component is engaged to the angled connection channel.

11. The system of claim 7, wherein the modular component is adjustable so as to permit engagement of the component to the connector in a connection channel of any angled orientation on the connector.

12. The system of claim 7 further comprising a second connector having at least one connection channel for secure slideable engagement of a modular component having a complementary configuration projection.

13. The system of claim 8 further comprising a second connector having at least one connection channel for secure slideable engagement to the modular component and at least one additional connection channel for slideable engagement to yet another complementary configuration projection.

14. The system of claim 7, wherein the modular component is an erasable whiteboard.

15. The system of claim 7, wherein the modular component comprises an rotatable projection for insertion into a complementary connection channel of the connector without need of sliding engagement of the component to the connector.
